(19) United States
(12) Patent Application Publication
(10) Pub. No.: US 2024/0110052 A1
(43) Pub. Date: Apr. 4, 2024

(54) Resin Pellet Group and Layer Structure Using Same

(71) Applicant: KURARAY CO., LTD., Okayama (JP)

(72) Inventors: Mizuko Oshita, Okayama (JP); Luyten Wout, Melsele (BE)

(73) Assignee: KURARAY CO., LTD., Okayama (JP)

(21) Appl. No.: 18/267,512

(22) PCT Filed: Dec. 16, 2021
(86) PCT No.: PCT/JP2021/046456

§ 371 Date: Jun. 15, 2023

(30) Foreign Application Priority Data
Dec. 17, 2020 (JP) 2020-209749

(51) Int. Cl. C08L 29/04; B29C 48/21; B32B 27/30

(52) U.S. Cl. CPC C08L 29/04; B29C 48/21; B32B 27/306; C08L 2201/14; C08L 2205/025; C08L 2205/18

(57) ABSTRACT

The present disclosure provides a resin pellet group including a pellet (A1) containing an ethylene-vinyl alcohol copolymer (a1), and a pellet (A2) containing an ethylene-vinyl alcohol copolymer (a2).

### TECHNICAL FIELD

The present invention relates to a resin pellet group and a layer structure using the same.

### BACKGROUND ART

Generally, ethylene-vinyl alcohol copolymers (hereinafter also referred to as “EVOH”) are superior in terms of transparency, gas barrier properties, aroma retaining properties, solvent resistance, oil resistance, and so forth. Utilizing these properties, EVOH is used for films, sheets, containers, and so forth as packaging materials for food, pharmaceuticals, industrial chemicals, agricultural chemicals, and so forth. In addition, utilizing their barrier properties, heat retaining properties, stain resistance, and so forth, EVOH is also used in applications for fuel tanks of vehicles such as an automobile, tube materials for tires, agricultural films, geomembranes, shoe cushioning materials, and so forth.

However, the EVOH has a large number of hydroxyl groups in its molecule, as well as high crystallinity and a high crystallization rate, and lacks flexibility. Therefore, it has been pointed out that the EVOH is inferior in terms of secondary processing suitability, in particular, heat stretchability when being molded into a packaging material or the like for food or the like.

As a solution to this problem, Patent Document 1 proposes a multilayer structure in which a layer composed of two kinds of EVOH having different melting points and a polypropylene layer are stacked with an adhesive resin layer interposed therebetween, in order to improve stretchability.

### RELATED ART DOCUMENTS

### Patent Document

Patent Document 1: JP 2000-318095A

### SUMMARY OF INVENTION

### Problem to be Solved by the Invention

However, for the multilayer structure according to Patent Document 1, due to heat-stretching molding in particular, the peel strength between the EVOH layer and the adhesion layer tends to vary among products after being formed into containers or the like, and therefore the quality stability may be insufficient.

The present invention is to solve the above-described problem, and an object thereof is to provide a resin pellet group, as well as a layer structure, a packaging material, and a container using the resin pellet group with which it is possible to obtain a molded body that is excellent in gas barrier properties and secondary processability, and is excellent in peel strength stability after secondary processing.

### Means for Solving the Problem

In other words, the invention is achieved by:
[1] a resin pellet group for being directly melt-molded, comprising: a pellet (A1) containing an EVOH (a1); and a pellet (A2) containing an EVOH (a2),
   wherein the pellet (A1) has a melt flow rate (hereinafter also referred to as “MFR”) of 2 g/10 min or more and less than 11 g/10 min at 210° C. under a load of 2160 g, as measured in accordance with JIS K 7210:2014, and the pellet (A2) has a MFR of 11 g/10 min or more and 40 g/10 min or less at 210° C. under a load of 2160 g, as measured in accordance with JIS K 7210:2014,
   an ethylene unit content (ECₐ₁) of the EVOH (a1) is different from an ethylene unit content (ECₐ₂) of the EVOH (a2), and
   a mass ratio (A1/A2) of the pellet (A1) to the pellet (A2) is 20/80 or more and 99/1 or less;
[2] the resin pellet group according to [1], wherein an absolute value of a difference between the ethylene unit content (ECₐ₁) of the EVOH (a1) and the ethylene unit content (ECₐ₂) of the ethylene-vinyl alcohol copolymer (a2) is 4 mol % or more;
[3] the resin pellet group according to [1] or [2], wherein the ethylene unit content (ECₐ₂) of the EVOH (a2) is larger than the ethylene unit content (ECₐ₁) of the EVOH (a1);
[4] the resin pellet group according to any one of [1] to [3], wherein the ethylene unit content (ECₐ₁) of the EVOH (a1) is 20 mol % or more and 50 mol % or less, and the ethylene unit content (ECₐ₂) of the EVOH (a2) is 30 mol % or more and 60 mol % or less;
[5] the resin pellet group according to any one of [1] to [4], wherein a difference between a melting point of the pellet (A1) and a melting point of the pellet (A2) is 8° C. or more and 35° C. or less;
[6] a layer structure comprising a gas barrier layer obtained by directly melt-molding the resin pellet group according to any one of [1] to [5];
[7] the layer structure according to [6], comprising a thermoplastic resin layer disposed on at least one side of the gas barrier layer;
[8] the layer structure according to [7], comprising a coextruded structure of the gas barrier layer and the thermoplastic resin layer;
[9] a packaging material comprising the layer structure according to any one of [6] to [8];
[10] a container comprising the layer structure according to any one of [6] to [8]; and
[11] a method for producing a layer structure, comprising
   a step of directly melt-molding a resin pellet group including a pellet (A1) containing an ethylene-vinyl alcohol copolymer (a1) and a pellet (A2) containing an ethylene-vinyl alcohol copolymer (a2), to form a gas barrier layer,
   wherein the pellet (A1) has a melt flow rate of 2 g/10 min or more and less than 11 g/10 min at 210° C. under a load of 2160 g, as measured in accordance with JIS K 7210:2014,
   the pellet (A2) has a melt flow rate of 11 g/10 min or more and 40 g/10 min or less at 210° C. under a load of 2160 g, as measured in accordance with JIS K 7210:2014,
   an ethylene unit content (ECₐ₁) of the ethylene-vinyl alcohol copolymer (a1) is different from an ethylene unit content (ECₐ₂) of the ethylene-vinyl alcohol copolymer (a2), and
   a mass ratio (A1/A2) of the pellet (A1) to the pellet (A2) is 20/80 or more and 99/1 or less.

### Effects of the Invention

According to the present invention, it is possible to obtain a resin pellet group, as well as a layer structure, a packaging material, and a container using the resin pellet group with which it is possible to obtain a molded body that is excellent in gas barrier properties and secondary processability, and is excellent in peel strength stability after secondary processing.

### BRIEF DESCRIPTION OF DRAWINGS

FIG. 1 is a schematic view of a twin-screw extruder used in Production Example 9.

FIG. 2 is a schematic view of a hot cutter used in Production Example 9.

### DESCRIPTION OF EMBODIMENT

(Resin Pellet Group)

A resin pellet group according to the present invention includes a pellet (A1) containing an EVOH (a1); and a pellet (A2) containing an EVOH (a2), wherein the pellet (A1) has a MFR of 2 g/10 min or more and less than 11 g/10 min at 210° C. under a load of 2160 g, as measured in accordance with JIS K 7210:2014, and the pellet (A2) has a MFR of 11 g/10 min or more and 40 g/10 min or less at 210° C. under a load of 2160 g, as measured in accordance with JIS K 7210:2014, an ethylene unit content (ECₐ₁) of the ethylene-vinyl alcohol copolymer (a1) is different from an ethylene unit content (ECₐ₂) of the ethylene-vinyl alcohol copolymer (a2), and a mass ratio (A1/A2) of the pellet (A1) to the pellet (A2) is 20/80 or more and 99/1 or less. By satisfying the above-described conditions, the pellet group of the present invention can provide a molded body (e.g., a layer structure) that is excellent in secondary processability while retaining the inherent gas barrier properties of the EVOH. Furthermore, surprisingly, the molded body is excellent in peel strength stability after secondary processing. Here, the expression “peel strength stability after secondary processing” means that, for example, when a gas barrier layer obtained by directly melt-molding the resin pellet group of the present invention is stacked on top of a layer for which another material is used, the peel strength between the gas barrier layer and the layer for which another material is stable after such a stack has been subjected to secondary processing. When the peel strength stability after secondary processing is favorable, variation in quality between products obtained through secondary processing can be suppressed. By including the pellets containing EVOH having different ethylene unit contents, the pellet group tends to be excellent in secondary processability while retaining the gas barrier properties. Since the resin pellet group contains the pellet (A1) and the pellet (A2) having specific MFRs, the resin pellet group tends to be excellent in peel strength stability after secondary processing.

Here, the term “resin pellet group” in the present specification means a collection of resin pellets. Therefore, the resin pellet group of the present invention is a collection of resin pellets in which the pellets include the pellet (A1) and the pellet (A2). Preferably, the resin pellet group of the present invention is a dry-blended body including the pellet (A1) and the pellet (A2). Here, the term “dry-blended body” in the present specification means a state in which the pellets constituting the resin pellet group are sufficiently mixed with each other. For example, the size of each of the resin pellets constituting the resin pellet group is not particularly limited, and the smallest unit of the resin pellet group is a dry-blended body constituted by a combination of one resin pellet of a certain kind and one resin pellet of another kind.

Both the EVOH (a1) and the EVOH (a2) respectively contained in the pellet (A1) and the pellet (A2) are copolymers obtained by saponifying an ethylene-vinyl ester copolymer, for example. The production and saponification of the ethylene-vinyl ester copolymer can be performed using known methods as will be described below. Examples of vinyl esters used in such methods include fatty acid vinyl esters such as vinyl acetate, vinyl formate, vinyl propionate, vinyl pivalate, and vinyl versatate.

The ethylene unit content (ECₐ₁) of the EVOH (a1) is different from the ethylene unit content (ECₐ₂) of the EVOH (a2). The absolute value (|ECₐ₁−ECₐ₂|) of a difference between the ethylene unit content (ECₐ₁) and the ethylene unit content (ECₐ₂) is preferably 4 mol % or more, more preferably 7 mol % or more, even more preferably 10 mol % or more, and particularly preferably 13 mol % or more. The absolute value (ECₐ₁−ECₐ₂|) of a difference between the ethylene unit contents is preferably 20 mol % or less, and more preferably 18 mol %. When the absolute value (|ECₐ₁−ECₐ₂|) of a difference between the ethylene unit contents is in the above-described range, both the secondary processability and the gas barrier properties tend to be satisfied. Preferably, the ethylene unit content (ECₐ₂) is larger than the ethylene unit content (ECₐ₁). When the ethylene unit content (ECₐ₂) is larger than the ethylene unit content (ECₐ₁), pellets having the desired MFRs are likely to be obtained.

The ethylene unit content (ECₐ₁) is preferably 20 mol % or more and 50 mol % or less, more preferably 22 mol % or more and 44 mol % or less, and even more preferably 24 mol % or more and 35 mol % or less. In contrast, the ethylene unit content (ECₐ₂) is preferably 30 mol % or more and 60 mol % or less, more preferably 35 mol % or more and 55 mol % or less, and even more preferably 40 mol % or more and 50 mol % or less. When the ethylene unit content (ECₐ₁) and the ethylene unit content (ECₐ₂) are in their respective ranges described above, both the secondary processability and the gas barrier properties tend to be satisfied. Both the ethylene unit content (ECₐ₁) of the EVOH (a1) and the ethylene unit content (ECₐ₂) of the EVOH (a2) can be measured using a nuclear magnetic resonance (NMR) method, for example.

Furthermore, in the resin pellet group of the present invention, the respective saponification degrees of the EVOH (a1) and the EVOH (a2) (i.e., the saponification degrees of the respective vinyl ester components of the EVOH (a1) and the EVOH (a2)) are, for example, preferably 85 mol % or more, more preferably 90 mol % or more, even more preferably 95 mol % or more, and particularly preferably 99 mol %. On the other hand, the respective saponification degrees of the EVOH (a1) and the EVOH (a2) are, for example, preferably 100 mol % or less, and may be 99.99 mol % or less. When the respective saponification degrees of the EVOH (a1) and the EVOH (a2) are in the above-described ranges, the resin pellet group of the present invention can have appropriate thermal stability. The above-described saponification degrees can each be calculated through ¹H-NMR measurement of the peak area of hydrogen atoms included in the vinyl ester unit and the peak area of hydrogen atoms included in the vinyl alcohol unit.

The EVOH (a1) and/or the EVOH (a2) may also include a unit derived from another monomer other than ethylene, vinyl ester, and saponified products thereof, as long as the object of the present invention is not impaired. When the EVOH (a1) and/or the EVOH (a2) includes another monomer unit, the content of the other monomer unit relative to all of the structural units of the EVOH (a1) and/or the EVOH (a2) may be, for example, 30 mol % or less, 20 mol % or less, 10 mol % or less, or 5 mol % or less. When the EVOH (a1) and/or the EVOH (a2) includes a unit derived from the other monomer, the content thereof may be, for example, 0.05 mol % or more, or 0.1 mol % or more.

Examples of another monomer include alkenes such as propylene, butylene, pentene, and hexene; ester group-containing alkenes such as 3-acyloxy-1-propene, 3-acyloxy-1-butene, 4-acyloxy-1-butene, 3,4-diacyloxy-1-butene, 3-acyloxy-4-methyl-1-butene, 4-acyloxy-1-butene, 3,4-diacyloxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-acyloxy-1-pentene, 5-acyloxy-1-pentene, 4,5-diacyloxy-1-pentene, 4-acyloxy-1-hexene, 5-acyloxy-1-hexene, 6-acyloxy-1-hexene, 5,6-diacyloxy-1-hexene, 1,3-diacetoxy-2-methylenepropane, or saponified products thereof; unsaturated acids such as acrylic acid, methacrylic acid, crotonic acid, itaconic acid, or anhydrides, salts, monoalkyl esters, or dialkyl esters thereof; nitriles such as acrylonitrile and methacrylonitrile; amides such as acrylamide and methacrylamide; olefin sulfonic acids such as vinyl sulfonic acid, allyl sulfonic acid, methallyl sulfonic acid, or salts thereof; vinylsilane compounds such as vinyltrimethoxysilane, vinyltriethoxysilane, vinyltri(β-methoxy-ethoxy)silane, and γ-methacryloxypropylmethoxysilane; alkyl vinyl ethers, vinyl ketones, N-vinylpyrrolidone, vinyl chloride, and vinylidene chloride.

The EVOH (a1) and/or the EVOH (a2) may be modified through urethanation, acetalization, cyanoethylation, oxyalkylenation, or the like as needed.

The EVOH (a1) and the EVOH (a2) can be obtained using a known method such as a bulk-polymerization method, a solution polymerization method, a suspension polymerization method, and an emulsion polymerization method. In one embodiment, a bulk-polymerization method or a solution polymerization method may be used in which polymerization can proceed without a solvent, or in a solution such as alcohol.

The solvent used in a solution polymerization method is not particularly limited, and examples thereof include alcohols, preferably lower alcohols such as methanol, ethanol, and propanol. The amount of the solvent used in a polymerization reaction solution may be selected taking into account the viscosity-average polymerization degree of the target EVOH or the chain transfer of the solvent, and the mass ratio (solvent/total monomers) of the solvent to the total monomers in the reaction solution is, for example, 0.01 to 10, and preferably 0.05 to 3.

Examples of a catalyst used in the above-described polymerization include azo-based initiators such as 2,2-azobisisobutyronitrile, 2,2-azobis-(2,4-dimethylvaleronitrile), 2,2-azobis-(4-methoxy-2,4-dimethylvaleronitrile), and 2,2-azobis-(2-cyclopropylpropionitrile); and organic peroxide-based initiators such as isobutyryl peroxide, cumyl peroxyneodecanoate, diisopropyl peroxycarbonate, di-n-propyl perpoxydicarbonate, t-butyl peroxyneodecanoate, lauroyl peroxide, benzoyl peroxide, and t-butyl hydroperoxide. The amount of the catalyst used in the polymerization is preferably 0.005 to 0.6 equivalents per vinyl ester component used in the polymerization.

The polymerization temperature is preferably 20° C. to 90° C., and more preferably 40° C. to 70° C. The polymerization time is preferably 2 hours to 15 hours, and more preferably 3 hours to 11 hours. The polymerization rate is preferably 10% to 90%, and more preferably 30% to 80%, relative to the vinyl ester charged. The resin content in the solution after the polymerization is preferably 5% to 85%, and more preferably 20% to 70%.

In the above-described polymerization, after polymerization has been performed for a predetermined time, or after a predetermined polymerization rate has been reached, a polymerization inhibitor is added as needed, and unreacted ethylene gas is removed through evaporation to remove unreacted vinyl ester, whereby an ethylene-vinyl ester copolymer solution is obtained.

An alkaline catalyst is added to the copolymer solution to saponify the copolymer. The saponification method may either be a continuous saponification method or a batch saponification method. Examples of the alkaline catalyst that can be added include sodium hydroxide, potassium hydroxide, and alkali metal alcoholates.

The EVOH that has been subjected to saponification reaction contains the alkaline catalyst, a by-product salt such as sodium acetate or potassium acetate, and other impurities, and it is therefore preferable to remove these impurities through neutralization or washing. Here, when the EVOH that has been subjected to saponification reaction is washed with water (e.g., ion exchanged water) that is substantially free of predetermined ions (e.g., metal ions and chloride ions), a by-product salt such as sodium acetate or potassium acetate need not be completely removed, and a portion thereof may be left. Each of the EVOH (a1) and the EVOH (a2) can be synthesized through the subsequent drying.

In the resin pellet group of the present invention, the pellet (A1) and the pellet (A2) each independently have a predetermined MFR.

Specifically, the pellet (A1) has an MFR of 2 g/10 min or more and less than 11 g/10 min, preferably 3 g/10 min or more and 9.5 g/10 min or less, and more preferably 3.5 g/10 min or more and 9 g/10 min or less at 210° C. under a load of 2160 g, as measured in accordance with JIS K 7210:2014. Here, when the MFR at 210° C. under a load of 2160 g is below 2 g/10 min, a kneading failure occurs during melt molding, resulting in reduced secondary processability. When the MFR at 210° C. under a load of 2160 g is 11 g/10 min or more, variation in the peel strength after secondary processing increases.

On the other hand, the pellet (A2) has an MFR of 11 g/10 min or more and 40 g/10 min or less, preferably 12 g/10 min or more and 30 g/10 min or less, and more preferably 12.5 g/10 min or more and 20 g/10 min or less at 210° C. under a load of 2160 g, as measured in accordance with JIS K 7210:2014. Here, when the MFR at 210° C. under a load of 2160 g is below 11 g/10 min, the variation in peel strength after secondary processing increases. When the MFR at 210° C. under a load of 2160 g is above 40 g/10 min, a kneading failure occurs during melt molding, resulting in reduced secondary processability.

The difference (A2−A1) between the MFR at 210° C. under a load of 2160 g of the pellet (A2) as measured in accordance with JIS K 7210:2014 and the MFR at 210° C. under a load of 2160 g of the pellet (A1) as measured in accordance with JIS K 7210:2014 is preferably 1.0 g/10 min or more, more preferably 3 g/10 min or more, even more preferably 7 g/10 min or more, and may be preferably 10 g/10 min or more. The MFR difference (A2−A1) is preferably 30 g/10 min or less, and may be 20 g/10 min or less, or 1530 g/10 min or less. When the MFR difference (A2−A1) is in the above-described range, the secondary processability, the peel strength stability after secondary processing, and the extrusion stability tend to be excellent.

In the present invention, the difference between the melting point of the pellet (A1) and the melting point of the pellet (A2) is preferably 8° C. or more and 35° C. or less, and more preferably 10° C. or more and 30° C. or less. When the difference between the melting point of the pellet (A1) and the melting point of the pellet (A2) is 8° C. or more, the secondary processability tends to be excellent. When the difference between the melting point of the pellet (A1) and the melting point of the pellet (A2) is 35° C. or less, the extrusion stability tends to be excellent.

Note that in the present invention, the melting point of the pellet (A1) is preferably 160° C. to 200° C., and more preferably 175° C. to 196° C. On the other hand, the melting point of the pellet (A2) is preferably 135° C. to 186° C., more preferably 145° C. to 175° C., and even more preferably 150° C. to 170° C. When the respective melting points of the pellet (A1) and the pellet (A2) are in the above-described ranges, both the secondary processability and the gas barrier properties tend to be satisfied.

The MFRs of the pellet (A1) and the pellet (A2) can be adjusted, for example, by the ethylene unit contents and the saponification degrees of the EVOH (a1) and the EVOH (a2), as well as the polymerization time, the amount of the polymerization catalyst, the polymerization temperature, or the like during synthesis of the EVOH (a1) and the EVOH (a2). The aforementioned MFRs can also be adjusted by the content of a boron compound described below.

The pellets (A1) and (A2) each independently contain other components such as a thermoplastic resin other than the EVOH (a1) and the EVOH (a2), a metal salt, an acid, a boron compound, a plasticizer, a filler, an anti-blocking agent, a lubricant, a stabilizer, a surfactant, a coloring agent, an ultraviolet absorber, an antistatic agent, a desiccant, a crosslinking agent, and a reinforcement material such as various fibers, as long as the effects of the present invention are not impaired.

Examples of the other thermoplastic resin include various polyolefins (e.g., polyethylene, polypropylene, poly1-butene, poly4-methyl-1-pentene, ethylene-propylene copolymers, copolymers of ethylene and α-olefin having 4 or more carbon atoms, copolymers of polyolefin and maleic anhydride, ethylene-vinyl ester copolymers, ethylene-acrylic acid ester copolymers, or modified polyolefins obtained through graft modification with an unsaturated carboxylic acid or an derivative thereof), various polyamides (e.g., nylon 6, nylon 6.6, nylon 6/66 copolymers, nylon 11, nylon 12, and polymethaxylylene adipamide), various polyesters (e.g., polyethylene terephthalate, polybutylene terephthalate, and polyethylene naphthalate), polyvinyl chloride, polyvinylidene chloride, polystyrene, polyacrylonitrile, polyurethane, polycarbonate, polyacetal, polyacrylate, and modified polyvinyl alcohol resins. Note that, from the viewpoint of improving the recyclability, the pellet group of the present invention preferably does not contain 20 parts by mass or more, more preferably 13 parts by mass or more, and even more preferably 5 parts by mass or more of various polyamides. It is further preferable that the pellet group of the present invention substantially does not contain various polyamides, and it is particularly preferable that the pellet group of the present invention does not contain various polyamides.

The above-described metal salt is preferably an alkali metal salt, and more preferably an alkaline-earth metal salt, from the viewpoint of improving the thermal stability. When the pellet (A1) and/or (A2) contains a metal salt, the lower limit of the content thereof is preferably, for example, 1 ppm or more, 5 ppm or more, 10 ppm or more, or 20 ppm or more in terms of the metal atom in the metal salt, based on the pellet (A1) or (A2). When the pellet (A1) and/or (A2) contains a metal salt, the upper limit of the content thereof is preferably, for example, 10000 ppm or less, 5000 ppm or less, 1000 ppm or less, or 500 ppm or less in terms of the metal atom in the metal salt, based on the pellet (A1) or (A2). When the metal salt content is in the above-described range, the thermal stability and the hue of the pellet (A1) and/or (A2) during melt molding are favorable.

From the viewpoint of increasing the thermal stability when melt-molding the pellets (A1) and (A2), the above-described acid is preferably a carboxylic acid compound, a phosphoric acid compound, or the like. When the pellet (A1) and/or (A2) contains a carboxylic acid compound, the content thereof is preferably 1 ppm or more, more preferably 10 ppm or more, and even more preferably 50 ppm or more. On the other hand, the content of the carboxylic acid compound is preferably 10000 ppm or less, more preferably 1000 ppm or less, and even more preferably 500 ppm or less. When the pellet (A1) and/or (A2) contains a phosphoric acid compound, the content thereof in terms of phosphoric acid radicals is preferably 1 ppm or more, more preferably 10 ppm or more, and even more preferably 30 ppm or more. On the other hand, the content of the phosphoric acid compound in terms of phosphoric acid radicals is preferably 10000 ppm or less, more preferably 1000 ppm or less, and even more preferably 300 ppm or less. When the content of the carboxylic acid compound or the phosphoric acid compound is in the above-described range, the thermal stability and the hue of the pellet (A1) and/or (A2) during melt molding are favorable.

When the pellet (A1) and/or (A2) contains the above-described boron compound, the content thereof is preferably 1 ppm or more, more preferably 10 ppm or more, and even more preferably 50 ppm or more. On the other hand, the content of the boron compound is preferably 2000 ppm or less, more preferably 1000 ppm or less, and even more preferably 500 ppm or less. When the content of the boron compound is in the above-described range, the thermal stability of the pellet (A1) and/or (A2) during melt molding tends to be favorable. In addition, the MFR tends to be increased when the boron compound is added.

The method for including the above-described other components in the pellet (A1) and/or (A2) is not particularly limited. For example, the other components may be added and kneaded when pelletizing a composition including the EVOH (a1) or the EVOH (a2) (i.e., when producing the pellet (A1) and/or (A2)). Examples of the method for adding the other components when producing the pellet (A1) and/or (A2) also include a method in which the other components are added in the form of a dry powder, a method in which the other components are added in the state of a paste impregnated with a predetermined solvent, a method in which the other components are added while being suspended in a predetermined liquid, a method in which the other components are dissolved in a predetermined solvent and added in the form of a solution, and a method in which the other components are immersed in a predetermined solution. Note that kneading need not be performed in the case of using the method in which the other components are immersed in a predetermined solution. Among these, the method in which a solution obtained by dissolving the above-described compounds in a predetermined solvent is added and kneaded, and the method in which the other components are immersed in a predetermined solution are preferable in that these compounds can be uniformly dispersed in the EVOH. The predetermined solvent is not particularly limited, but is preferably water from the viewpoints of solubility of the compounds to be added, cost, handleability, work environment safety, and so forth.

From the viewpoint of further exhibiting the effects of the present invention, the proportion of the EVOH (a1) in the pellet (A1) is preferably 90 mass % or more, more preferably 95 mass % or more, even more preferably 97 mass % or more, and particularly preferably 99 mass % or more, and the pellet (A1) may essentially consist only of the EVOH (a1). The proportion of the EVOH (a2) in the pellet (A2) is preferably 90 mass % or more, more preferably 95 mass % or more, even more preferably 97 mass % or more, and particularly preferably 99 mass % or more, and the pellet (A1) may essentially consist only of EVOH (a2). The total content of the EVOH (a1) and the EVOH (a2) in the resin pellet group of the present invention is preferably greater than 95 mass %, more preferably 97 mass % or more, and even more preferably 99 mass % or more, based on the total mass.

The resin pellet group of the present invention contains the pellet (A1) and the pellet (A2) at a predetermined mass ratio (A1/A2).

Specifically, the mass ratio (A1/A2) of the pellet (A1) to the pellet (A2) is 20/80 or more and 99/1 or less, preferably 50/50 or more and 93/7 or less, and more preferably 70/30 or more and 87/13 or less. When the mass ratio (A1/A2) is less than 20/80 (i.e., when the content of the pellet (A2) is less than 20 parts by mass relative to 80 parts by mass of the pellet (A1)), the gas barrier properties are degraded. When the mass ratio (A1/A2) is above 99/1 (i.e., when the content of the pellet (A2) is less than 1 part by mass relative to 99 parts by mass of the pellet (A1)), the secondary processability is reduced. When the mass ratio (A1/A2) of the pellet (A1) to the pellet (A2) is in the above-described range, a molded body that is excellent in gas barrier properties and is excellent in secondary processability can be obtained using the resin pellet group of the present invention.

The pellet group of the present invention may include a pellet other than the pellet (A1) and the pellet (A2). The proportion of the pellet (A1) and the pellet (A2) in the pellet group of the present invention is preferably 90 mass % or more, more preferably 96 mass % or more, even more preferably 98 mass % or more, and particularly preferably 99 mass % or more. The pellet group of the present invention may essentially consist only of the pellet (A1) and the pellet (A2), and the pellet group of the present invention may consist only of the pellet (A1) and the pellet (A2).

In obtaining a desired molded body, the resin pellet group of the present invention is directly melt-molded for use. Here, the term “directly” in the expression “directly melt-molding” used in the present specification refers to directly using the pellets (A1) and (A2), which are the contents of the resin pellet group of the present invention, for producing a resin molded body, with each of the pellets (A1) and (A2) being kept in a pellet form (i.e., with the pellets (A1) and (A2) being dry-blended) in order to obtain a desired resin molded body, without being pelletized in advance, for example, through melt kneading. The term “resin molded body” used in the present specification encompasses a molded body obtained through secondary processing (molding) using a resin pellet, and specifically refers to a molded body other than a pellet.

For example, when the pellets (A1) and (A2) are melt-kneaded in advance to form melt-kneaded pellets, and a molded body is obtained using the melt-kneaded pellets, the peel strength after secondary processing varies. In contrast, when the resin pellet group of the present invention is melt-kneaded in the state of a dry-blended body of the pellets (A1) and (A2), and used for producing a predetermined molded body (melt-molded body), a molded body excellent in the peel strength stability after secondary processing can be obtained, surprisingly.

(Layer Structure)

A layer structure of the present invention is a structure composed of one or more layers, and includes a gas barrier layer obtained by directly melt-molding the resin pellet group of the present invention. From the viewpoint of further improving the gas barrier properties (e.g., oxygen-barrier properties), the layer structure may include either one gas barrier or a plurality of gas barrier layers, and the materials forming the gas barrier layers may be the same or different. The gas barrier layer is a layer having a function of preventing gas permeation, and, for example, has an oxygen transmission rate of 100 cm³·20 μm/(m²·day·atm) or less, preferably 50 cm³·20 μm/(m²·day·atm) or less, and more preferably 10 cm³·20 μm/(m²·day·atm), as measured in accordance with JIS K 7126 (isopiestic method) under the conditions of 20° C. and 65% RH. Here, an oxygen transmission rate of “100 cm³·20 μm/(m²·day·atm)” means that the amount of oxygen permeation per day per m² of a 20 μm-thick film under 1 atmosphere of oxygen is 100 cm³.

The number of layers in the layer structure of the present invention may be one, and preferably two or more. The number of layers in the layer structure of the present invention may be 13 or less. When the number of layers in the layer structure of the present invention is in the above-described range, favorable mechanical strength tends to be achieved.

According to the present invention, the average thickness of a single gas barrier layer obtained by directly melt-molding the resin pellet group is not necessarily limited, but is, for example, preferably 0.5 μm or more, and more preferably 1 μm or more, and may be preferably 3 μm or more. On the other hand, the average thickness of a single gas barrier layer may be, for example, 200 μm or less, or 100 μm or less. Here, the “average thickness” in the present specification is an average value of thicknesses measured at five randomly selected locations. When the average thickness of a single gas barrier layer is in the above-described range, the durability, flexibility, and appearance properties of the layer structure of the present invention tend to be favorable.

The gas barrier layer obtained by directly melt-molding the resin pellet group of the present invention preferably includes a matrix phase containing the EVOH (a1) as a main component, and a dispersion phase containing the EVOH (a2) as a main component. Here, the “main component” means a component constituting more than 50 mass % of a phase. The proportion of the EVOH (a1) in components constituting the matrix phase is preferably 80 mass % or more, more preferably 90 mass % or more, even more preferably 95 mass % or more, and particularly preferably 98 mass % or more, and the matrix phase may essentially consist only of the EVOH (a1). The proportion of the EVOH (a2) in components constituting the dispersion phase is preferably 80 mass % or more, more preferably 90 mass % or more, even more preferably 95 mass % or more, and particularly preferably 98 mass % or more, and the dispersion phase may essentially consist only of the EVOH (a2). When the gas barrier layer includes such a matrix phase and dispersion phase, it is possible to satisfy both the secondary processability and the gas barrier properties, while achieving favorable peel strength stability after secondary processing. According to the present invention, when the gas barrier layer includes the matrix phase and the dispersion phase described above, the dispersion phase may exist in the form of particles having an average particle size of preferably 200 nm or more and 1.0 μm or less, more preferably 220 nm or more and 750 nm or less, and even more preferably 240 nm or more and 500 nm or less. When the average particle size of the particles constituting the dispersion phase is 200 nm or more, the peel strength stability after secondary processing tends to be excellent. When the average particle size of the particles constituting the dispersion phase is 1 μm or less, both the secondary processability and the gas barrier properties tend to be satisfied.

The average particle size of the particles constituting the dispersion phase can be adjusted by adjusting, for example, the mixing ratio or the kneading condition of the EVOH (a1) and the EVOH (a2). Examples of specific methods for adjusting the kneading conditions, for example, in the case of using a single-screw extruder include a method in which the resin residence time is adjusted according to the shape and the groove depth of the screw, and a method in which the shear viscosity is adjusted. As for the screw shape, for example, a full flighted screw or a barrier screw may be used. In order to adjust the kneading strength, a screw having a shape such as Maddock or Dulmage may be used. Additionally, the screw rotation rate may be adjusted to increase the shear rate. A twin-screw extruder may be used because the screw shape can be easily changed. In the case of using a twin-screw extruder, it is possible to use, for example, a method in which the length of the kneading disk is adjusted to adjust the kneading strength.

As a specific kneading condition in the case of using a single-screw extruder, for example, the lower limit of a shear rate r in the metering section of a melt extruder, as calculated from the following general expression (1) is preferably 10 sec⁻¹, more preferably 15 sec⁻¹, and particularly preferably 20 sec⁻¹. The upper limit of the shear rate r is preferably 100 sec⁻¹, more preferably 95 sec⁻¹, and particularly preferably 90 sec⁻¹. When kneading is performed under the condition in the above-described range, the average particle size of the particles constituting the dispersion phase can be easily adjusted in an appropriate range, and the linear cuttability tends to be favorable.

$$\begin{matrix}[ Numerical Expression 1 ] & \\ r = \frac{π \cdot DN}{60 \cdot h} & ( 1 )\end{matrix}$$

In Expression (1), D represents the cylinder diameter (cm), N represents the screw rotation rate (rpm), h represents the groove depth 5 (cm) of the metering section, and r represents the shear rate (sec⁻¹).

The layer structure of the present invention may include, other than the gas barrier layer obtained by directly melt-molding the resin pellet group, at least one other gas barrier layer. Examples of the material forming the other gas barrier layer include, but are not necessarily limited to, EVOH, polyamides, polyesters, polyvinylidene chloride, acrylonitrile copolymers, polyvinylidene fluoride, polychlorotrifluoroethylene, polyvinyl alcohol, and inorganic vapor-deposited bodies (e.g., obtained by vapor-depositing, on a predetermined base material, an inorganic substance such as aluminum, tin, indium, nickel, titanium, chromium, a metal oxide, a metal nitride, a metal oxynitride, a metal carbonitride). Among these, EVOH is preferable in terms of the melt moldability and the gas barrier properties.

When the layer structure of the present invention includes another gas barrier layer, the thickness of the other gas barrier layer is not particularly limited, and a person skilled in the art may select any thickness as long as the actions and effects of the gas barrier layer obtained by directly melt-molding the resin pellet group are not impaired.

In addition to the gas barrier layer, the layer structure of the present invention may include a thermoplastic resin layer.

From the viewpoint of improving the impact resistance, the number of thermoplastic resin layers in the layer structure of the present invention is preferably one or more, and more preferably two or more. The number of thermoplastic resin layers may be 13 or less. Note that, when the layer structure includes a plurality of thermoplastic resin layers, the materials forming the layers may be the same or different.

The thermoplastic resin layer contains a thermoplastic resin as a main component. The thermoplastic resin layer may contain, as a main component, a single kind of thermoplastic resin or a mixture of a plurality of kinds of thermoplastic resins. The proportion of the thermoplastic resin in the thermoplastic resin layer is preferably 80 mass % or more, more preferably 90 mass % or more, and even more preferably 99 mass % or more, and the thermoplastic resin layer may essentially consist only of the thermoplastic resin. The stretchability and thermoformability of the layer structure of the present invention can be improved by stacking the thermoplastic resin layer containing a thermoplastic resin as a main component.

The average thickness of a single thermoplastic resin layer is preferably 10 μm or more, and more preferably 20 μm or more. The average thickness of a single thermoplastic resin layer may be 1000 μm or less, 500 μm or less, or 400 μm or less. When the average thickness of a single thermoplastic resin layer is 10 μm or more, the thickness can be easily adjusted when the thermoplastic resin layers are stacked, and it is thus possible to further increase the durability of the layer structure. When the average thickness of a single thermoplastic resin layer is 1000 μm or less, favorable thermoformability tends to be achieved.

The thermoplastic resin that forms the thermoplastic resin layer is not particularly limited as long as the thermoplastic resin is softened and exhibits plasticity when heated to a glass transition temperature or melting point, and examples thereof include polyolefin resins (e.g., polyethylene resins and polypropylene resins), grafted polyolefin resins obtained through graft modification with an unsaturated carboxylic acid or an ester thereof, halogenated polyolefin resins, ethylene-vinyl acetate copolymer resins, ethylene-acrylic acid copolymer resins, ethylene-acrylic acid ester copolymer resins, polyester resins, polyamide resins, polyvinyl chloride resins, polyvinylidene chloride resins, acrylic resins, polystyrene resins, vinyl ester resins, ionomers, polyester elastomers, polyurethane elastomers, and aromatic or aliphatic polyketones. In particular, polyolefin resins are preferable because of their favorable mechanical strength and moldability, and polyethylene resins and polypropylene resins are more preferable.

The thermoplastic resin layer may contain an additive as long as the object of the present invention is not impaired. Examples of the additive include resins other than the above-described thermoplastic resins, heat stabilizers, ultraviolet absorbers, antioxidants, colorants, and fillers. When the thermoplastic resin layer contains an additive, the content of the additive is preferably 20 mass % or less, more preferably 10 mass % or less, and even more preferably 5 mass % or less, relative to the total amount of the thermoplastic resin layer.

In the layer structure of the present invention, it is preferable that the thermoplastic resin layer is disposed on at least one side of the gas barrier layer. Here, the expression “disposed on at least one side” means that the thermoplastic resin layer may be directly stacked on the gas barrier layer, or may be stacked with an adhesion layer interposed between the thermoplastic resin layer and the gas barrier layer. When the thermoplastic resin layer is disposed in this manner, the mechanical strength tends to be increased.

Also, it is preferable that the layer structure of the present invention includes a coextruded structure of the gas barrier layer and the thermoplastic resin. The term “coextruded structure of the gas barrier layer and the thermoplastic resin” used in the present specification refers to a stacked structure formed by co-extrusion of the gas barrier layer and the thermoplastic resin layer. When the layer structure includes such a coextruded structure, the mechanical strength tends to be increased.

Furthermore, the layer structure of the present invention may include at least one adhesion layer. The adhesion layer may be disposed between the gas barrier layer and the thermoplastic resin layer, for example. The number of adhesion layers included in the layer structure is not particularly limited. When the layer structure of the present invention includes the adhesion layer, it is possible to increase the interlayer adhesion between the gas barrier layer and the thermoplastic resin layer. When the layer structure of the present invention includes a plurality of adhesion layers, the materials forming the layers may be the same or different.

A known adhesive resin can be used as a material forming the adhesion layer. The material forming the adhesion layer may be selected as appropriate by a person skilled in the art according to the production method of the layer structure.

For example, when the layer structure of the present invention is produced using a lamination method, it is possible to form the adhesion layer using, for example, a two-component polyurethane-based adhesive in which a polyisocyanate component and a polyol component are mixed and reacted. Also, it is possible to further improve the adhesion by adding a small amount of an additive such as a known silane coupling agent to the adhesion layer.

Alternatively, when the layer structure of the present invention is produced using a co-extrusion molding method, the material used for the adhesion layer is not particularly limited as long as the material has adhesion to the gas barrier layer and the thermoplastic resin layer. For example, it is possible to use an adhesive resin containing a carboxylic acid-modified polyolefin. A modified olefin-based polymer containing a carboxyl group obtained by chemically (e.g., through addition reaction or graft reaction) bonding ethylenically unsaturated carboxylic acid, an ester thereof, or an anhydride thereof to an olefin-based polymer can be suitably used as the carboxylic acid-modified polyolefin. Here, examples of the olefin-based polymer include polyolefins such as polyethylene (e.g., low-pressure polyethylene, medium-pressure polyethylene, and high-pressure polyethylene), linear low-density polyethylene, polypropylene, and polybutene, and copolymers of an olefin and another monomer (e.g., vinyl ester or unsaturated carboxylic acid ester) such as an ethylene-vinyl acetate copolymer and an ethylene-acrylic acid ethyl ester copolymer. A linear low-density polyethylene, an ethylene-vinyl acetate copolymer (with a vinyl acetate content of 5 to 55 mass %), and an ethylene-acrylic acid ethyl ester copolymer (with an acrylic acid ethyl ester content of 8 to 35 mass %) are preferable, and the linear low-density polyethylene and the ethylene-vinyl acetate copolymer are particularly preferable. Examples of ethylenically unsaturated carboxylic acid, an ester thereof, or an anhydride thereof include ethylenically unsaturated monocarboxylic acid or an ester thereof, and ethylenically unsaturated dicarboxylic acid, or a monoester or diester thereof or an anhydride thereof. Among these, ethylenically unsaturated dicarboxylic anhydride is preferable. Specific examples thereof include maleic acid, fumaric acid, itaconic acid, maleic anhydride, itaconic anhydride, maleic acid monomethyl ester, maleic acid monoethyl ester, maleic acid diethyl ester, and fumaric acid monomethyl ester, and maleic anhydride is particularly preferable.

The addition amount or the yield of grafting (degree of modification) of the ethylenically unsaturated carboxylic acid or the anhydride thereof to the olefin-based polymer is, for example, 0.0001 mass % to 15 mass %, and preferably 0.001 mass % to 10 mass %, relative to the olefin-based polymer. The addition reaction or graft reaction of the ethylenically unsaturated carboxylic acid or the anhydride thereof with the olefin-based polymer can be performed using a radical polymerization method or the like in the presence of a solvent (e.g., xylene) and a catalyst (e.g., a peroxide), for example. The thus-obtained carboxylic acid-modified polyolefin has an MFR of preferably 0.2 g/10 min to 30 g/10 min, and more preferably 0.5 g/10 min to 10 g/10 min at 210° C. under a load of 2160 g, as measured in accordance with JIS K 7210:2014. These adhesive resins may be used alone or as a mixture of two or more.

The stacking order of the layer structure of the present invention is not particularly limited, and examples thereof include T/E/T, E/Ad/T, and T/Ad/E/Ad/T where E represents the gas barrier layer, Ad represents the adhesion layer, and T represents the thermoplastic resin layer. Each of the layers constituting the layer structure may be composed of a single layer or multiple layers. From the viewpoint of increasing the impact resistance, it is preferable that the layer structure includes a thermoplastic resin layer as the outermost layer.

When the layer structure of the present invention is a multilayer structure, the layer structure can be produced using a known method such as a co-extrusion molding method, a co-injection molding method, an extrusion lamination method, and a dry lamination method. Examples of the co-extrusion molding method include a co-extrusion lamination method, a co-extrusion sheet forming method, a co-extrusion inflation molding method, and a co-extrusion blow molding method. Examples of the layer structures obtained using such methods include sheets, films, and parisons.

(Applications)

The layer structure of the present invention is excellent in the gas barrier properties as well as in the peel strength stability after secondary processing. For example, a sheet, film, parison, or the like of the layer structure of the present invention is reheated at a temperature lower than or equal to the melting point of the resin contained in the multilayer structure, and is uniaxially or biaxially stretched according to a thermoforming method such as draw forming, a roll stretching method, a pantograph stretching method, an inflation stretching method, or a blow molding method, whereby a desired stretched multilayer structure can be obtained.

The layer structure of the present invention may also be used as a packaging material or a container for packaging or housing predetermined content, for example. Examples of the content include food (e.g., fresh food, processed food, refrigerated food, frozen food, freeze-dry food, ready-prepared food, and half-cooked food); beverages (e.g., drinking water, tea drinks, milk beverages, processed milk, soy milk, coffee, cocoa, soft drinks, soup, alcoholic beverages (e.g., beer, wine, white distilled liquor, Japanese sake, whiskey, and brandy); pet food (e.g., dog food and cat food); fodder or feed for livestock, domestic fowls, farmed fish; fats and oils (e.g., cooking oil and industrial oil); pharmaceuticals (e.g., pharmaceuticals for pharmacies, pharmaceuticals requiring guidance, OTC pharmaceuticals, and animal pharmaceuticals); and other medicines.

### EXAMPLES

Hereinafter, the present invention will be described in detail by way of examples; however, the present invention is not limited to these examples.

(Evaluation Methods)

(1) Ethylene Unit Content and Saponification Degree

EVOH pellets obtained in the production examples were dissolved in DMSO-d6, then subjected to ¹H-NMR measurement (JNM-GX-500 Model, manufactured by JEOL Ltd), to measure the ethylene unit contents and the saponification degrees.

(2) Melt Flow Rate (MFR)

The MFRs of the EVOH pellets obtained in the production examples were measured in accordance with the method described in JIS K 7210:2014. Specifically, the EVOH pellets were filled into a cylinder having an inner diameter of 9.55 mm and a length of 162 mm of a melt indexer L244 (manufactured by Takara Kogyo Co., Ltd.), and melted at 210° C. Thereafter, using a plunger having a mass of 2,160 g and a diameter of 9.48 mm, a load was uniformly applied to the melted resin composition. The amount of the resin composition (g/10 min) extruded per unit time from an orifice having a diameter of 2.1 mm formed in the center of the cylinder was measured.

(3) Quantitative Determination of Sodium Ions, Phosphoric Acid, and Boric Acid

In a Teflon (registered trademark) pressure container, 0.5 g of the EVOH pellets obtained in the production examples were placed, and 5 mL of concentrated nitric acid was added thereto for decomposition at room temperature for 30 minutes. After 30 minutes had elapsed, the lid of the pressure container was closed, and decomposition was carried out through heating at 150° C. for 10 minutes, and subsequently at 180° C. for 5 minutes, using a wet digestion system (“MWS-2” manufactured by Actac Corp.), followed by cooling to room temperature. The processing solution was transferred to a 50 mL volumetric flask (manufactured by TPX (registered trademark)), which was then filled up with pure water. This solution was subjected to elementary analysis using an ICP emission spectrophotometer (“OPTIMA 4300 DV” manufactured by PerkinElmer, Inc.), to calculate the amount of sodium ions (elemental sodium), the amount of phosphoric acid in terms of phosphoric acid radicals, and the boric acid content. Note that a calibration curve created using a commercially available standard solution was used for the quantitative determination of each component.

(4) Acetic Acid Content

In 100 ml of ion exchanged water, 20 g of the EVOH pellets obtained in the production examples was placed, and then subjected to extraction under heating at 95° C. for 6 hours. The extract was subjected to neutralization titration with 1/50 N NaOH using phenolphthalein as an indicator, and the acetic acid content was calculated. Note that the phosphoric acid content was taken into account when calculating the acetic acid content.

(5) Gas Barrier Properties (OTR)

The resin pellet groups obtained in the examples and the comparative examples were formed into films under the following conditions, to obtain monolayer films having a thickness of 20 μm. After the obtained monolayer films had been subjected to humidity control under the conditions of 20° C./65% RH, the oxygen transmission rate was measured under the conditions of 20° C./65% RH, using an oxygen transmission rate measurement apparatus (“OX-Tran 2/20” manufactured by ModernControls Inc.). Note that this measurement was performed in accordance with ISO 14663-2 annex C.

(Film-Forming Conditions)
Apparatus: 20-mm-diameter single-screw extruder (D2020, manufactured by Toyo Seiki Seisaku-sho, Ltd.)
L/D: 20
Screw: full flighted
Die width: 30 cm
Take-up roll temperature: 80° C.
Screw rotation rate: 40 rpm
Take-up roll speed: 3.0 to 3.5 m/min
Set temperature: C1/C2/C3/D=180/200/220/220 (° C.)

(6) Thermoformability (Secondary Processability)

Using each of the resin pellet groups (EVOH) obtained in the examples and the comparative examples as a gas barrier layer, polypropylene “NOVATEC (trademark) PP EA7AD” (PP) manufactured by Japan Polypropylene Corporation as a thermoplastic resin layer, and adhesive polyolefin “ADMER (trademark) QF 500” (Ad1) manufactured by Mitsui Chemicals, Inc. as an adhesion layer, a multilayer structure composed of five layers of three kinds (PP/Ad/EVOH/Ad/PP=368 μm/16 μm/32 μm/16 μm/368 μm) was obtained under the following conditions. Note that a film-forming facility including an extruder with a film-forming die and a temperature-controllable take-up roll disposed downstream of the extruder was used, and the obtained multilayer structure was wound using a winder.

(Film-Forming Conditions)

Extruder for EVOH: single-screw extruder (laboratory equipment model ME CO-EXT, manufactured by Toyo Seiki Seisaku-sho, Ltd.)
Bore with 20 mm in diameter, L/D=20, full flighted-type screw
   Supply section/compression section/metering section/die=175° C./210° C./220° C./230° C.

Extruder for PP: single-screw extruder (GT-32-A, manufactured by Research Laboratory of Plastics Technology Co., Ltd.)
Bore with 32 mm in diameter, L/D=28, full flighted-type screw
   Supply section/compression section/metering section/die=170/200/210/230(° C.)

Extruder for Ad1: single-screw extruder (SZW20GT-20MG-STD, manufactured by TECHNOVEL CORPORATION)
Bore with 20 mm in diameter, L/D=20, full flighted-type screw
Supply section/compression section/metering section/die=150/200/220/220(° C.)
Die: 300-mm-wide coat hanger die (manufactured by Research Laboratory of Plastics Technology Co., Ltd.)
Take-up roll temperature: 80° C.

Using a thermoforming machine (manufactured by Asano Seisakusho Co. Ltd.), the obtained multilayer structure was thermoformed (using compressed air: 5 kg/cm², plug: 45 mm in diameter×65 mm, syntax form, die temperature: 40° C.) at a sheet temperature of 150° C. into a cup shape (die shape with 70 mm in diameter×70 mm, draw ratio S=1.0), to form a thermoformed container. A bottom portion of the formed container was visually evaluated according to the following criteria. Note that a thermoformed container corresponding to criterion D would have a poor appearance and be difficult to use for packing applications, and therefore, a thermoformed container corresponding to any of criteria A to C was determined as having favorable secondary processability.

(Criteria)
A: Uniform with no variations observed.
B: Very few streaky variations were observed.
C: Some streaky variations were observed.
D: Significant variations were observed.

(7) Peel Strength

A portion at a position 2 cm away from the bottom of a trunk portion of the thermoformed container obtained in the evaluation method (6) above was cut out with a width of 1.5 cm around one entire circumference of the thermoformed container, and thereafter the T-peel strength was measured at a tensile speed of 250 mm/min in an atmosphere of 23° C. and 50% RH, using an autograph “Model AGS-H” manufactured by SHIMADZU CORPORATION. In the measurement, the peel strength between the Ad layer and the EVOH layer inside the thermoformed container was measured. The measurement was carried out for 10 samples, and the average value and the standard deviation thereof were determined. It was determined that the smaller the standard deviation, the more stable the adhesion, and the higher the quality stability.

(8) Extrusion Stability

Each of the resin pellet groups obtained in the examples and the comparative examples were subjected to an extrusion test under the following conditions, and the extrusion stability thereof was evaluated. After the apparatus had been operated for 30 minutes at various rotation rates, the difference between the maximum pressure and the tip pressure of the cylinder was measured, and the average value of differences (three locations) in the pressure differential at the various rotation rates was evaluated under the following conditions. Note that the extrusion stability was determined as being stable when the resin pellet group corresponded to any of criteria A to C.
Apparatus: 40-mm-diameter single-screw extruder (GT-40-A, manufactured by Research Laboratory of Plastics Technology Co., Ltd.)
L/D: 26
Compression ratio: 3.0
Screw: full flighted
Screw rotation rate: 30, 60, 90 rpm
   Set temperature: C1/C2/C3/AD/H1/Die=180/200/220/220/220/220 (° C.)

(Criteria)
A: Less than 2 MPa
B: 2 MPa or more and less than 3 MPa
C: 3 MPa or more and less than 4 MPa
D: 4 MPa or more

### Production Example 1: Production of EVOH (A1-1) Pellets

In a 200 L pressurized reaction tank provided with a jacket, a stirrer, a nitrogen inlet, an ethylene inlet, and an initiator addition port, 75.0 kg of vinyl acetate (hereinafter may be referred to as VAc), and 7.2 kg of methanol (hereinafter may be referred to as MeOH) were charged, and the inside of the reaction tank was purged with a nitrogen gas through nitrogen bubbling for 30 minutes. Then, after the temperature inside the reaction tank had been adjusted to 65° C., ethylene was introduced such that the reaction tank pressure (ethylene pressure) was 4.13 MPa, and 9.4 g of 2,2′-azobis(2,4-dimethylvaleronitrile) (“V-65” manufactured by FUJIFILM Wako Pure Chemical Corporation) was added thereto as an initiator, to initiate polymerization. During polymerization, the ethylene pressure was maintained at 4.13 MPa, and the polymerization temperature at 65° C. After 4 hours had elapsed, when the VAc conversion ratio (polymerization rate in terms of VAc) reached 49.7%, cooling was performed, and 37.5 g of sorbic acid dissolved in 25 kg methanol was placed in the container to terminate the polymerization. The reaction tank was opened to effect deethylation, followed by nitrogen gas bubbling to complete the deethylation. Then, the polymerized solution was extracted from the container, and diluted with 20 L of MeOH. This solution was fed from the top of the column of a column-type container, and MeOH vapor was fed from the bottom of the column to remove unreacted monomers remaining in the polymerized solution together with MeOH vapor, to obtain a MeOH solution of an ethylene-vinyl acetate copolymer (hereinafter may be referred to as EVAc).

Then, 100 kg of a 20 mass % MeOH solution of EVAc was charged in a 300 L reaction tank provided with a jacket, a stirrer, a nitrogen inlet, a reflux condenser, and a solution addition port. While blowing nitrogen gas into the solution, the temperature was raised to 60° C., and a MeOH solution having a sodium hydroxide concentration of 2 N was added for two hours at a rate of 300 mL/min. After the addition of the sodium hydroxide MeOH solution was complete, a saponification reaction was allowed to proceed through stirring for 2 hours, while keeping the temperature in the system at 60° C. and allowing MeOH and methyl acetate produced by saponification reaction to flow out of the reaction tank. Thereafter, 5.8 kg of acetic acid was added thereto to terminate the saponification reaction.

Thereafter, while stirring under heating at 80° C., 75 L of ion exchanged water was added to cause MeOH to flow out of the reaction tank and to precipitate EVOH. The precipitated EVOH was collected through decantation and ground with a grinder. The resulting EVOH powder was placed in a 1 g/L aqueous acetic acid solution (bath ratio 20: a ratio of 20 L of the aqueous solution to 1 kg of the powder), and stirred and washed for 2 hours. The resulting powder was deliquified, then further placed in a 1 g/L aqueous acetic acid solution (bath ratio 20), and stirred and washed for 2 hours. The powder resulting from deliquification thereof was placed in ion exchanged water (bath ratio 20), and stirred and washed for 2 hours for deliquification. This series of operations was repeated three times to perform purification. Then, the resultant was immersed, under stirring, for 4 hours in 250 L of an aqueous solution containing acetic acid at 0.5 g/L and sodium acetate at 0.1 g/L, and thereafter deliquified. The resultant was dried for 16 hours at 60° C., to obtain 10.1 kg of a roughly dried EVOH. The above-described series of operations was performed again to obtain 10.2 kg of a roughly dried EVOH, thereby obtaining a total of 20.3 kg of a roughly dried EVOH (A1-1).

In a 60 L stirring tank provided with a jacket, a stirrer, and a reflux condenser, 20 kg of the roughly dried EVOH (A1-1) obtained as above, 8 kg of water, and 22 kg of MeOH were charged, and stirred for 5 hours at 60° C. for complete dissolution, thus obtaining a resin composition solution. This solution was extruded, through a metal plate having a diameter of 4 mm, in a liquid mixture of water/MeOH=90/10 (volume ratio) cooled to −5° C. so as to be precipitated in the form of a strand. This strand was cut into pellets using a strand cutter, to obtain EVOH hydrous pellets. The moisture content of the obtained EVOH hydrous pellets was 52 mass %, as measured using a halogen moisture meter “HR73” manufactured by Mettler Co. Ltd. The obtained EVOH hydrous pellets were placed in a 1 g/L aqueous acetic acid solution (bath ratio 20), and stirred and washed for 2 hours. The resulting pellets were deliquified, further placed in a 1 g/L aqueous acetic acid solution (bath ratio 20), and stirred and washed for 2 hours. After deliquification, the aqueous acetic acid solution was renewed, and the same operation was performed. The pellets that were washed with the aqueous acetic acid solution and then deliquified were placed in ion exchanged water (bath ratio 20), and stirred and washed for 2 hours for further deliquification. This series of operations was repeated 3 times, to obtain EVOH hydrous pellets from which the catalyst residue from the saponification reaction had been removed.

The hydrous pellets were placed in an aqueous solution (bath ratio 20) having a sodium acetate concentration of 0.510 g/L, an acetic acid concentration of 0.8 g/L, and a phosphoric acid concentration of 0.04 g/L, and immersed, with periodic stirring, for 4 hours to perform chemical treatment. The pellets were deliquified, and dried under a stream of nitrogen having an oxygen concentration of 1 vol % or less for 3 hours at 80° C., and 16 hours at 105° C., thereby obtaining cylindrical EVOH (A1-1) pellets (moisture content 0.3 mass %) containing acetic acid, sodium ions (sodium salt), and phosphoric acid and having an average diameter of 2.8 mm and an average length of 3.2 mm.

### Production Examples 2 to 8, 11: Production of EVOH (A1-2) Pellets to EVOH (A1-5) Pellets, and EVOH (A2-1) Pellets to EVOH (A2-4) Pellets

EVOH (A1-2) pellets to EVOH (A1-5) pellets, and EVOH (A2-1) pellets to EVOH (A2-4) pellets were produced in the same manner as in Production Example 1 except that the polymerization conditions and the saponification conditions of the EVOH was set as shown in Table 1, and that the aqueous solution used in the chemical treatment was changed to an aqueous solution (bath ratio 20) having a sodium acetate concentration of 0.510 g/L, an acetic acid concentration of 0.8 g/L, a phosphoric acid concentration of 0.04 g/L, and a boric acid concentration of 0.57 g/L in Production Examples 2, 4, 5 and 11.

### Production Example 9: Production of EVOH (A1-1) Pellets

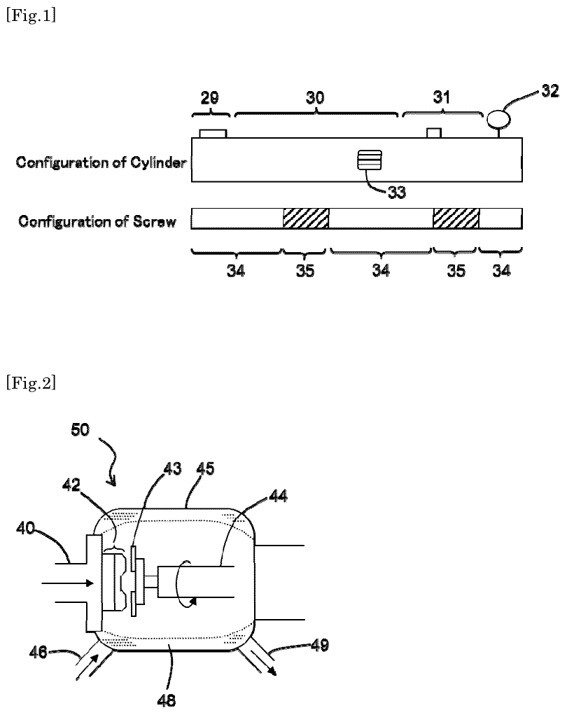

EVOH hydrous pellets were obtained in the same manner as in Production Example 1. The hydrous pellets were placed in ion exchanged water (bath ratio 20), stirred and washed for 2 hours, and deliquified. This series of operations was repeated 3 times. Surface water was removed from 10 kg of the deliquified pellets using a centrifugal separator. The hydrous pellets, which had been centrifugally dried to have a moisture content of 33 mass %, were placed in a twin-screw extruder shown in FIG. 1, and melt-kneaded under the following conditions, with the resin temperature at an ejection port set to 100° C., while adding a processing solution constituted by an aqueous acetic acid/sodium acetate/phosphoric acid solution from a minor component adding section at a distal end portion on the ejection port side. The amount of EVOH charged per unit time was 10 kg/hr (including the weight of water contained), the amount of the processing solution charged per unit time was 0.67 L/hr, and the processing solution was an aqueous solution having a composition containing acetic acid at 6.7 g/L, sodium acetate at 11.3 g/L, and phosphoric acid at 1 g/L. Note that the twin-screw extruder shown in FIG. 1 was composed of a raw material supply section 29, a deliquifying section 30, and a minor component adding section 31, with the deliquifying section 30 including a wedge wire dewatering slit 33, and the screw being a combination of a full flighted screw 34 and a reverse flighted screw 35 as shown in FIG. 1. Furthermore, the twin-screw extruder included a temperature sensor 32 at the cylinder end.

(Conditions for Twin-Screw Extruder)
Apparatus: 30-mm-diameter twin-screw extruder
L/D: 45.5
Screw: Co-rotating fully intermeshing type
Screw rotation rate: 300 rpm
Cylinder temperature: 100° C.
Die temperature: 105° C.
Number of die holes: 5 holes (3 mm in diameter)
Take-up speed: 5 m/min

Thereafter, the molten EVOH resin ejected from the twin-screw extruder was cut using a hot cutter 50 shown in FIG. 2, to obtain substantially spherical pellets. Note that, in the hot cutter 50 shown in FIG. 2, the molten EVOH resin was supplied from an EVOH supply port 40 to a die 42 in a cutter box 45, and then cut by a rotary blade 43 rotated by a rotational shaft 44, whereby EVOH hydrous pellets were obtained. On the other hand, in the cutter box 45, a water film 48 was formed by cooling water supplied from a cooling water supply port 46, the EVOH hydrous pellets cut with the rotary blade 43 were cooled by the water film 48, and discharged from a pellet discharge port 49 together with the cooling water. The substantially spherical pellets had a moisture content of 20 mass %. The resulting pellets were dried under a stream of nitrogen for 15 hours at 90° C., and 15 hours at 105° C., thereby obtaining substantially spherical EVOH (A1-1) pellets (moisture content 0.3 mass %) having a minor diameter of 2.7 mm and a major diameter of 3.7 mm.

### Production Example 10: Production of EVOH (A2-1) Pellets

EVOH hydrous pellets were obtained in the same manner as in Production Example 5. EVOH (A2-1) pellets (substantially spherical, minor diameter 2.7 mm, major diameter 3.7 mm) were obtained in the same manner as in Production Example 9 except that the aforementioned hydrous pellets were used, and that the composition of the processing solution added in the twin-screw extruder was changed to the following composition. The processing solution was an aqueous solution having a composition containing acetic acid at 6.7 g/L, sodium acetate at 11.3 g/L, phosphoric acid at 1 g/L, and boric acid at 9 g/L.

The ethylene unit content, saponification degree, MFR, the sodium ion amount, phosphoric acid amount, boric acid amount, and acetic acid amount of the EVOH (A1-1) pellets to the EVOH (A1-4) pellets, the EVOH (A2-1) pellets to the EVOH (A2-4) pellets, the EVOH (A1-1′) pellets, and the EVOH (A2-1′) pellets obtained in Production Examples 1 to 10 were measured in accordance with the methods described in the evaluation methods (1) to (4) above. The results are shown in Table 2. For all of the EVOH pellets, the sodium ion content was 100 ppm, the amount of phosphoric acid in terms of phosphoric acid radicals was 40 ppm, and the acetic acid content was 200 ppm.

TABLE 1

| | Production | Production | Production | Production | Production |
|---|---|---|---|---|---|
| | Example 1 | Example 2 | Example 3 | Example 4 | Example 5 |
| Name of Pellet | EVOH(A1-1) | EVOH(A1-2) | EVOH(A1-3) | EVOH(A1-4) | EVOH(A2-1) |
| Pressurized Reaction | 200 | 100 | 100 | 100 | 100 |
| Tank(L) | | | | | |
| VAc (kg) | 75 | 40 | 40 | 40 | 40 |
| MeOH (kg) | 7.2 | 17.4 | 16.1 | 3.6 | 6.8 |
| Ethylene Pressure (MPa) | 4.13 | 2.87 | 2.92 | 5.7 | 5.97 |
| Polymerization Initiator | Initiator 1 | Initiator 1 | Initiator 1 | Initiator 1 | Initiator 1 |
| Polymerization Initiator | 9.4 | 13.2 | 13.2 | 9.6 | 23.2 |
| Content (g) | | | | | |
| Temperature in Reaction | 65 | 60 | 60 | 65 | 60 |
| Tank (° C.) | | | | | |
| Reaction Time (hr) | 4 | 3 | 3 | 4 | 4 |
| VAc Conversion Ratio (%) | 49.7 | 44.9 | 45.2 | 54.8 | 54.7 |
| Charge Amount for | 150 | 100 | 100 | 100 | 100 |
| Saponification (kg) | | | | | |
| Addition Rate of NaOH/MeOH | 450 | 300 | 300 | 300 | 300 |
| Solution (mL/min) | | | | | |

| | Production | Production | Production | Production |
|---|---|---|---|---|
| | Example 6 | Example 7 | Example 8 | Example 11 |
| Name of Pellet | EVOH(A2-2) | EVOH(A2-3) | EVOH(A2-4) | EVOH(A1-5) |
| Pressurized Reaction | 100 | 100 | 100 | 100 |
| Tank(L) | | | | |
| VAc (kg) | 40 | 40 | 40 | 40 |
| MeOH (kg) | 1.9 | 14.1 | 14.2 | 13.2 |
| Ethylene Pressure (MPa) | 5.84 | 3.95 | 3.59 | 4.35 |
| Polymerization Initiator | Initiator 1 | Initiator 1 | Initiator 1 | Initiator 1 |
| Polymerization Initiator | 9.2 | 13.6 | 12.4 | 15.0 |
| Content (g) | | | | |
| Temperature in Reaction | 65 | 60 | 60 | 60 |
| Tank (° C.) | | | | |
| Reaction Time (hr) | 4 | 4 | 4 | 4 |
| VAc Conversion Ratio (%) | 55.2 | 49.8 | 50.1 | 49.9 |
| Charge Amount for | 100 | 100 | 100 | 100 |
| Saponification (kg) | | | | |
| Addition Rate of NaOH/MeOH | 300 | 300 | 300 | 300 |
| Solution (mL/min) | | | | |

Initiator 1: 2,2′-azobis(2,4-dimethylvaleronitrile) (“V-65” manufactured by FUJIFILM Wako Pure Chemical Corporation)

TABLE 2

| | | Ethylene Unit | Saponification | MFR | Boric Acid |
|---|---|---|---|---|---|
| | | Content | Degree | (g/10 min, | Content |
| | Name of Pellet | (mole %) | (mole %) | 210° C.) | (ppm) |
| Production Example 1 | EVOH(A1-1) | 32.12 | 99.78 | 3.8 | 0 |
| Production Example 2 | EVOH(A1-2) | 27.32 | 99.85 | 4.0 | 800 |
| Production Example 3 | EVOH(A1-3) | 27.24 | 99.99 | 8.9 | 0 |
| Production Example 4 | EVOH(A1-4) | 44.28 | 99.98 | 3.3 | 800 |
| Production Example 5 | EVOH(A2-1) | 47.88 | 99.99 | 15 | 800 |
| Production Example 6 | EVOH(A2-2) | 43.98 | 99.89 | 13 | 0 |
| Production Example 7 | EVOH(A2-3) | 34.97 | 99.99 | 21 | 0 |
| Production Example 8 | EVOH(A2-4) | 32.05 | 99.99 | 12 | 0 |
| Production Example 9 | EVOH(A1-1′) | 32.12 | 99.78 | 3.8 | 0 |
| Production Example 10 | EVOH(A2-1′) | 47.88 | 99.99 | 15 | 800 |
| Production Example 11 | EVOH(A1-5) | 38.06 | 99.99 | 3.8 | 800 |

### Example 1: Production and Evaluation of Resin Pellet Group

85 parts by mass of the EVOH (A1-1) pellets obtained in Production Example 1 and 15 parts by mass of the EVOH WA-1) pellets obtained in Production Example 5 were dry-blended to form a resin pellet group. The OTR, secondary processability, peel strength, and extrusion stability of the obtained resin pellet group were evaluated in accordance with the methods described in the evaluation methods (5) to (8) above. The results are shown in Table 3.

### Examples 2 to 11 and Comparative Examples 1 to 2: Production and Evaluation of Resin Pellet Groups

Resin pellet groups were produced and evaluated in the same manner as in Example 1 except that combinations of EVOH pellets shown in Table 3 were used. The results are shown in Table 3 or Table 4.

### Comparative Example 3: Production and Evaluation of EVOH Melt-Kneaded Pellets

85 parts by mass of the EVOH (A1-1) pellets obtained in Production Example 1 and 15 parts by mass of the EVOH (A2-1) pellets obtained in Production Example 5 were dry-blended, and melt-kneaded under the extrusion conditions shown below, thereby producing melt-kneaded pellets. Evaluation was performed in the same manner as in Example 1 except that the melt-kneaded pellets were used in place of the resin pellet group of Example 1. The results are shown in Table 4.

(Extrusion Conditions)
Extruder: Twin-screw extruder “Labo Plastomill” manufactured by Toyo Seiki Seisaku-sho, Ltd.
Screw diameter: 25 mm
Screw rotation rate: 100 rpm
Feeder rotation rate: 80 rpm
Cylinder, die temperature setting: C1/C2/C3/C4/C5/Die=180/210/220/220/220/220 (° C.)

### Comparative Example 4: Evaluation of EVOH Pellets

Evaluation was performed in the same manner as in Example 1 except that the EVOH (A1-1) pellets obtained in Production Example 1 were used as a resin pellet group in place of the resin pellet group of Example 1. The results are shown in Table 4.

60 parts by mass of the EVOH (A1-1) pellets obtained in Production Example 1, 10 parts by mass of the EVOH (A1-5) pellets obtained in Production Example 11, and 30 parts by mass of the EVOH (A2-2) pellets obtained in Production Example 6 were dry-blended to produce a resin pellet group. The OTR, secondary processability, peel strength, and extrusion stability of the obtained resin pellet group were evaluated in accordance with the methods described in the evaluation methods (5) to (8) above. The results were as follows: the OTR was 0.5 cm³·20 μm/m²·day·atm, the peel strength was 273.9 g/15 mm, and the standard deviation of the peel strength was 38.2. The appearance of the bottom portion the resulting thermoformed container was A, and the extrusion stability was A.

### Example 13: Production and Evaluation of Resin Pellet Group

40 parts by mass of the EVOH (A1-1) pellets obtained in Production Example 1, 30 parts by mass of the EVOH (A1-5) pellets obtained in Production Example 11, and 30 parts by mass of the EVOH (A2-2) pellets obtained in Production Example 6 were dry-blended to produce a resin pellet group. The OTR, secondary processability, peel strength, and extrusion stability of the obtained resin pellet group were evaluated in accordance with the methods described in the evaluation methods (5) to (8) above. The results were as follows: the OTR was 0.6 cm³·20 μm/m²·day·atm, the peel strength was 271.1 g/15 mm, and the standard deviation of the peel strength was 39.5. The appearance of the bottom portion of the resulting thermoformed container was A, and the extrusion stability was A.

TABLE 3

| | | | | Example 1 | Example 2 | Example 3 | Example 4 | Example 5 |
|---|---|---|---|---|---|---|---|---|
| Pellet | Pellet | Name of Pellet (EVOH) | | A1-1 | A1-1 | A1-1 | A1-1 | A1-1 |
| Group | (A1) | Ethylene Unit Content | mole % | 32 | 32 | 32 | 32 | 32 |
| | | MFR | g/10 min | 3.8 | 3.8 | 3.8 | 3.8 | 3.8 |
| | | Melting Point | ° C. | 183 | 183 | 183 | 183 | 183 |
| | | Appearance | | Cylindrical | Cylindrical | Cylindrical | Cylindrical | Cylindrical |
| | | Parts by mass | | 85 | 50 | 95 | 90 | 75 |
| | Pellet | Type | | A2-1 | A2-1 | A2-1 | A2-1 | A2-1 |
| | (A2) | Ethylene Unit Content | mole % | 48 | 48 | 48 | 48 | 48 |
| | | MFR | g/10 min | 15 | 15 | 15 | 15 | 15 |
| | | Melting Point | ° C. | 157 | 157 | 157 | 157 | 157 |

| | | | | | |
|---|---|---|---|---|---|
| Appearance | Cylindrical | Cylindrical | Cylindrical | Cylindrical | Cylindrical |
| Parts by mass | 15 | 50 | 5 | 10 | 25 |

| | | | | | | | |
|---|---|---|---|---|---|---|---|
| | Difference in MFR | g/10 min | 11.2 | 11.2 | 11.2 | 11.2 | 11.2 |
| | Difference in Et³⁾ | mole % | 16 | 16 | 16 | 16 | 16 |
| | Difference between Melting Points | ° C. | 26 | 26 | 26 | 26 | 26 |
| Evaluation | OTR | Unit²⁾ | 0.4 | 1.0 | 0.3 | 0.3 | 0.5 |
| | Peel Strength | g/15 mm | 278.2 | 264.5 | 283.2 | 280.2 | 274.2 |

| | | | | | |
|---|---|---|---|---|---|
| Standard Deviation of Peel Strength | 41.7 | 50.4 | 40.5 | 41.2 | 45.2 |
| Appearance of Bottom Portion of Thermoformed | A | A | C | B | A |
| Container(Secondary Processability) | | | | | |
| Extrusion Stability | A | A | A | A | A |

| | | | | Example 6 | Example 6 | Example 7 | Example 8 |
|---|---|---|---|---|---|---|---|
| Pellet | Pellet | Name of Pellet (EVOH) | | A1-2 | A1-3 | A1-3 | A1-1 |
| Group | (A1) | Ethylene Unit Content | mole % | 27 | 27 | 27 | 32 |
| | | MFR | g/10 min | 4 | 8.9 | 8.9 | 3.8 |
| | | Melting Point | ° C. | 190 | 190 | 190 | 183 |

| | Appearance | | Cylindrical | Cylindrical | Cylindrical | Cylindrical |
|---|---|---|---|---|---|---|
| | Parts by mass | | 75 | 85 | 60 | 85 |
| Pellet | Type | | A2-2 | A2-2 | A2-3 | A2-1′ |
| (A2) | Ethylene Unit Content | mole % | 44 | 44 | 35 | 48 |
| | MFR | g/10 min | 13 | 13 | 21 | 15 |
| | Melting Point | ° C. | 165 | 165 | 177 | 157 |

| | | | | |
|---|---|---|---|---|
| Appearance | Cylindrical | Cylindrical | Cylindrical | Substantially |
| | | | | Spherical |
| Parts by mass | 25 | 15 | 40 | 15 |

| | | | | | | |
|---|---|---|---|---|---|---|
| | Difference in MFR | g/10 min | 9 | 4.1 | 12.1 | 11.2 |
| | Difference in Et³⁾ | mole % | 17 | 17 | 8 | 16 |
| | Difference between Melting Points | ° C. | 25 | 25 | 13 | 26 |
| Evaluation | OTR | Unit²⁾ | 0.3 | 0.2 | 0.2 | 0.4 |
| | Peel Strength | g/15 mm | 286.4 | 288.5 | 288.2 | 278.5 |

| | | | | |
|---|---|---|---|---|
| Standard Deviation of Peel Strength | 46.3 | 67.2 | 42.3 | 42.5 |
| Appearance of Bottom Portion of Thermoformed | A | A | C | A |
| Container(Secondary Processability) | | | | |
| Extrusion Stability | A | B | A | A |

¹⁾The body was so uneven that a sample could not be obtained to measure peel strength.
²⁾cm³ · 20 μm/m² · day · atm
³⁾Absolute Value of Difference between Ethylene Unit Contents

TABLE 4

| | | | | | | | Comparative | |
|---|---|---|---|---|---|---|---|---|
| | | | | Example 9 | Example 10 | Example 11 | Example 1 | |
| Pellet | Pellet | Name of Pellet (EVOH) | | A1-1′ | A1-4 | A1-2 | A1-2 | A1-4 |
| Group | (A1) | Ethylene Unit Content | mole % | 32 | 44 | 27 | 27 | 44 |
| | | MFR | g/10 min | 3.8 | 3.3 | 4 | 4 | 3.3 |
| | | Melting Point | ° C. | 183 | 165 | 190 | 190 | 165 |

| Appearance | Substantially | Cylindrical | Cylindrical | Cylindrical | Cylindrical |
|---|---|---|---|---|---|
| | Spherical | | | | |
| Parts by mass | 85 | 85 | 75 | 75 | 25 |

| Pellet | Type | | A2-1′ | A2-3 | A2-4 | — |
|---|---|---|---|---|---|---|
| (A2) | Ethylene Unit Content | mole % | 48 | 35 | 32 | — |
| | MFR | g/10 min | 15 | 21 | 12 | — |
| | Melting Point | ° C. | 157 | 177 | 183 | — |

| Appearance | Substantially | Cylindrical | Cylindrical | — |
|---|---|---|---|---|
| | Spherical | | | |
| Parts by mass | 15 | 15 | 25 | 1 |

| | | | | | | |
|---|---|---|---|---|---|---|
| | Difference in MFR | g/10 min | 11.2 | 17.7 | 8 | 17 |
| | Difference in Et³⁾ | mole % | 16 | 9 | 5 | 0.7 |
| | Difference between Melting Points | ° C. | 26 | 12 | 7 | 25 |
| Evaluation | OTR | Unit²⁾ | 0.4 | 1.5 | 0.1 | 0.3 |
| | Peel Strength | g/15 mm | 278.3 | 258.6 | 293.2 | 385 |

| | | | | |
|---|---|---|---|---|
| Standard Deviation of Peel Strength | 42.2 | 35.2 | 80.5 | 192.3 |
| Appearance of Bottom Portion of Thermoformed | A | A | C | A |
| Container(Secondary Processability) | | | | |
| Extrusion Stability | A | A | C | D |

| | | | | Comparative | | Comparative | Comparative |
|---|---|---|---|---|---|---|---|
| | | | | Example 2 | | Example 3 | Example 4 |
| Pellet | Pellet | Name of Pellet (EVOH) | | A1-1 | A1-4 | A1-1 | A1-1 |
| Group | (A1) | Ethylene Unit Content | mole % | 32 | 44 | 32 | 32 |
| | | MFR | g/10 min | 3.8 | 3.3 | 3.8 | 3.8 |
| | | Melting Point | ° C. | 183 | 165 | 183 | 183 |

| | | | | |
|---|---|---|---|---|
| Appearance | Cylindrical | Cylindrical | — | Cylindrical |
| Parts by mass | 75 | 25 | 85 | 100 |

| Pellet | Type | | — | — | — |
|---|---|---|---|---|---|
| (A2) | Ethylene Unit Content | mole % | — | 48 | — |
| | MFR | g/10 min | — | 15 | — |
| | Melting Point | ° C. | — | 157 | |

| | | | |
|---|---|---|---|
| Appearance | — | — | — |
| Parts by mass | 1 | 15 | — |

| | | | | | |
|---|---|---|---|---|---|
| | Difference in MFR | g/10 min | 12 | 11.2 | — |
| | Difference in Et³⁾ | mole % | 0.5 | 16 | 2 |
| | Difference between Melting Points | ° C. | 18 | 26 | — |
| Evaluation | OTR | Unit²⁾ | 0.4 | 0.4 | 0.3 |
| | Peel Strength | g/15 mm | 298.5 | 302.5 | —¹⁾ |

| | | | |
|---|---|---|---|
| Standard Deviation of Peel Strength | 185.4 | 110.3 | —¹⁾ |
| Appearance of Bottom Portion of Thermoformed | A | A | D |
| Container(Secondary Processability) | | | |
| Extrusion Stability | D | C | D |

¹⁾The body was so uneven that a sample could not be obtained to measure peel strength.
²⁾cm³ · 20 μm/m² · day · atm
³⁾Absolute Value of Difference between Ethylene Unit Contents

As is clear from Tables 3 and 4, all of the monolayer films obtained by directly melt-molding the resin pellet groups of Examples 1 to 11 had excellent gas barrier properties as evident from the results for the OTR. In addition, it can be seen that all of the thermoformed containers obtained using the resin pellet groups of Examples 1 to 11 had a significantly lower value of the standard deviation of the peel strength, as compared with the containers obtained using the resin pellet groups of Comparative Examples 1 to 3, and had favorable adhesion between the Ad layer and the EVOH layer, and excellent quality stability. Furthermore, it can be seen that the resin pellet groups of Examples 1 to 11 retained a quality that was favorable or sufficiently usable in terms of both the secondary processability into the thermoformed container and the extrusion stability in the single-screw extruder, as compared with the resin pellet groups of Comparative Examples 1 to 4.

### INDUSTRIAL APPLICABILITY

The resin pellet group according to the present invention is useful for packaging for various products in technical fields such as those relating to food and beverages, pet food, fat and oil industries, and pharmaceuticals, for example.

### REFERENCE SIGNS LIST

29 Raw material supply section
30 Deliquifying section
31 Minor component adding section
32 Temperature sensor
33 Dewatering slit
34 Full flighted screw
35 Reverse flighted screw
40 EVOH supply port
42 Die
43 Rotary blade
45 Cutter box
46 Cooling water supply port
48 Water film
49 Pellet discharge port
50 Hot cutter

1. A resin pellet group, comprising:
a pellet (A1) containing an ethylene-vinyl alcohol copolymer (a1); and
a pellet (A2) containing an ethylene-vinyl alcohol copolymer (a2),
wherein the pellet (A1) has a melt flow rate of 2 g/10 min or more and less than 11 g/10 min at 210° C. under a load of 2160 g, as measured in accordance with JIS K 7210:2014, and the pellet (A2) has a melt flow rate of 11 g/10 min or more and 40 g/10 min or less at 210° C. under a load of 2160 g, as measured in accordance with JIS K 7210:2014,
an ethylene unit content (ECₐ₁) of the ethylene-vinyl alcohol copolymer (a1) is different from an ethylene unit content (ECₐ₂) of the ethylene-vinyl alcohol copolymer (a2), and
a mass ratio (A1/A2) of the pellet (A1) to the pellet (A2) is 20/80 or more and 99/1 or less.

2. The resin pellet group according to claim 1, wherein an absolute value of a difference between the ethylene unit content (ECₐ₁) of the ethylene-vinyl alcohol copolymer (a1) and the ethylene unit content (ECₐ₂) of the ethylene-vinyl alcohol copolymer (a2) is 4 mol % or more.

3. The resin pellet group according to claim 1, wherein the ethylene unit content (ECₐ₂) of the ethylene-vinyl alcohol copolymer (a2) is larger than the ethylene unit content (ECₐ₁) of the ethylene-vinyl alcohol copolymer (a1).

4. The resin pellet group according to claim 1, wherein the ethylene unit content (ECₐ₁) of the ethylene-vinyl alcohol copolymer (a1) is 20 mol % or more and 50 mol % or less, and the ethylene unit content (ECₐ₂) of the ethylene-vinyl alcohol copolymer (a2) is 30 mol % or more and 60 mol % or less.

5. The resin pellet group according to claim 1, wherein a difference between a melting point of the pellet (A1) and a melting point of the pellet (A2) is 8° C. or more and 35° C. or less.

6. A layer structure comprising a gas barrier layer obtained by directly melt-molding the resin pellet group according to claim 1.

7. The layer structure according to claim 6, comprising a thermoplastic resin layer disposed on at least one side of the gas barrier layer.

8. The layer structure according to claim 7, comprising a coextruded structure of the gas barrier layer and the thermoplastic resin layer.

9. A packaging material comprising the layer structure according to claim 6.

10. A container comprising the layer structure according to claim 6.

11. A method for producing a layer structure, comprising
directly melt-molding the resin pellet group according to claim 1 to form a gas barrier layer.
